(19) United States
(12) Patent Application Publication
(10) Pub. No.: US 2024/0167821 A1
(43) Pub. Date: May 23, 2024

(54) INFORMATION PROCESSING APPARATUS, INFORMATION PROCESSING METHOD, AND INFORMATION PROCESSING PROGRAM

(71) Applicant: SONY GROUP CORPORATION, TOKYO (JP)

(72) Inventors: KENEI MATSUDAIRA, TOKYO (JP); TAKAHIRO TSUJII, TOKYO (JP); YASUTAKA FUKUMOTO, TOKYO (JP)

(21) Appl. No.: 18/551,166

(22) PCT Filed: Feb. 28, 2022
(86) PCT No.: PCT/JP2022/008154

§ 371 Date: Sep. 18, 2023

(30) Foreign Application Priority Data
Mar. 29, 2021 (JP) 2021-055972

(51) Int. Cl. G01C 21/00; G08G 1/01

(52) U.S. Cl. CPC G01C 21/005; G08G 1/0133

(57) ABSTRACT

There are provided an information processing apparatus, an information processing method, and an information processing program by which a situation of a physical body in the surroundings of a moving body can be estimated with high accuracy. The information processing apparatus includes a situation estimation unit that estimates, on the basis of movement locus data indicative of a movement locus of a moving body and environment data indicative of an environment in the surroundings of the moving body, a situation of a physical body in the surroundings of the moving body.

### TECHNICAL FIELD

The present technology relates to an information processing apparatus, an information processing method, and an information processing program.

### BACKGROUND ART

Conventionally, there has been proposed a technology which analyzes a movement of a person or a moving body in order to utilize it in fields such as traffic flow measurement, measurement of a crowdedness with people, and customer flow analysis in a shop and the like.

For example, there has been proposed a technology which acquires position information of a moving body with high accuracy and analyzes meanings of a motion of each moving body in real time from a time transition of the position information (PTL 1).

### CITATION LIST

### Patent Literature

### PTL 1

Japanese Patent Laid-Open No. 2009-77019

### SUMMARY

### Technical Problem

However, since the technology disclosed in PTL 1 is based only on the movement of a moving body that moves together with a person or a thing that is a detection target, an element other than the moving body, for example, a person, an obstacle, or the like in the surroundings of the moving body, is not reflected. Therefore, estimation of a motion of the moving body or a situation of a physical body in the surroundings of the moving body cannot be performed accurately.

The present technology has been made in view of such a point as described above, and it is an object of the present technology to provide an information processing apparatus, an information processing method, and an information processing program by which a situation of a physical body in the surroundings of a moving body can be estimated with high accuracy.

### Solution to Problem

In order to solve the problem described above, the first technology is an information processing apparatus including a situation estimation unit that estimates, on the basis of movement locus data indicative of a movement locus of a moving body and environment data indicative of an environment in surroundings of the moving body, a situation of a physical body in the surroundings of the moving body.

Meanwhile, the second technology is an information processing method including estimating, on the basis of movement locus data indicative of a movement locus of a moving body and environment data indicative of an environment in surroundings of the moving body, a situation of a physical body in the surroundings of the moving body.

Further, the third technology is an information processing program for causing a computer to execute an information processing method including estimating, on the basis of movement locus data indicative of a movement locus of a moving body and environment data indicative of an environment in surroundings of the moving body, a situation of a physical body in the surroundings of the moving body.

### BRIEF DESCRIPTION OF DRAWINGS

FIG. 1 is a block diagram depicting a configuration of an information processing system 10.

FIG. 2 is a block diagram depicting a configuration of a sensor apparatus 100.

FIG. 3 is a block diagram depicting a configuration of an information processing apparatus 200.

FIG. 4 is a block diagram depicting a configuration of a server apparatus 400.

FIG. 5 is a block diagram depicting a configuration of an estimation result processing apparatus 300.

FIG. 6 is a block diagram depicting a configuration of a terminal apparatus 500.

FIG. 7 is a flow chart depicting a process by the information processing apparatus 200.

FIG. 8 is an explanatory view of a pre-process for movement locus data.

FIG. 9 is an explanatory view of ToF data.

FIG. 10 depicts views each depicting an example of time and data regarding the distance between a moving body and a physical body.

FIG. 11 depicts views each depicting a particular example of a situation of a moving body and a physical body.

FIG. 12 depicts views each depicting an example of time and data regarding the distance between a moving body and a physical body.

FIG. 13 depicts views each depicting an example of time and data regarding the distance between a moving body and a physical body.

FIG. 14 depicts views each depicting an example in which an estimation result is displayed on a map.

FIG. 15 is a view depicting the sensor apparatus 100 used in an experiment.

FIG. 16 is an explanatory view of the experiment.

FIG. 17 is a view depicting the number of pieces of data acquired in the experiment.

FIG. 18 is an explanatory view of movement locus data and ToF data acquired in the experiment.

FIG. 19 depicts tables indicative of correct answer rates by crowdedness estimation according to the conventional technology and crowdedness estimation according to the present technology.

### DESCRIPTION OF EMBODIMENT

In the following, an embodiment of the present technology is described with reference to the drawings. It is to be noted that the description is given in the following order.
<1. Embodiment>
[1-1. Configuration of information processing system 10]
[1-2. Configuration of sensor apparatus 100]
[1-3. Configuration of information processing apparatus 200]
[1-4. Configuration of estimation result processing apparatus 300]
[1-5. Process by information processing apparatus 200]
[1-6. Experiment result]
<2. Modification>

### 1. Embodiment

### [1-1. Configuration of Information Processing System 10]

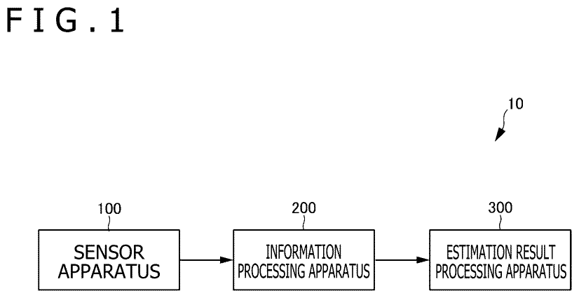

A configuration of an information processing system 10 is described with reference to FIG. 1. The information processing system 10 includes a sensor apparatus 100, an information processing apparatus 200, and an estimation result processing apparatus 300. The sensor apparatus 100, the information processing apparatus 200, and the estimation result processing apparatus 300 are connected to each other through a network.

The sensor apparatus 100 acquires and transmits, to the information processing apparatus 200, movement locus data indicative of a movement locus of a moving body and environment data that is data relating to an environment in the surroundings of the moving body. The information processing apparatus 200 estimates a situation of a physical body that is present in the surroundings of the moving body, on the basis of the movement locus data and the environment data, and further estimates whether or not the surroundings of the moving body are crowded. A situation estimation result and a crowdedness estimation result are transmitted to the estimation result processing apparatus 300. The estimation result processing apparatus 300 performs a predetermined process for the situation estimation result and the crowdedness estimation result.

Anything may be applied as the moving body if it is movable, and, for example, the moving body is a person, an animal, a vehicle such as an automobile or a bicycle, a drone, a robot, or the like. The present embodiment is described assuming that the moving body is a person. The surroundings of the moving body are, for example, a range within which environment data can be acquired by the sensor apparatus 100, and the range is, for example, a range from several meters to several tens meters in radius depending upon a performance of the sensor apparatus 100.

The physical body includes both a person and a thing. A person is moving in some cases and stays in place in other cases. The thing includes a thing at rest, a thing that is moving, a movable thing, and an immovable thing. In particular, as the thing, for example, a signboard, an automobile, a bicycle, a roadside tree, a utility pole, a mailbox, a fence, an animal, or the like is available.

### [1-2. Configuration of Sensor Apparatus 100]

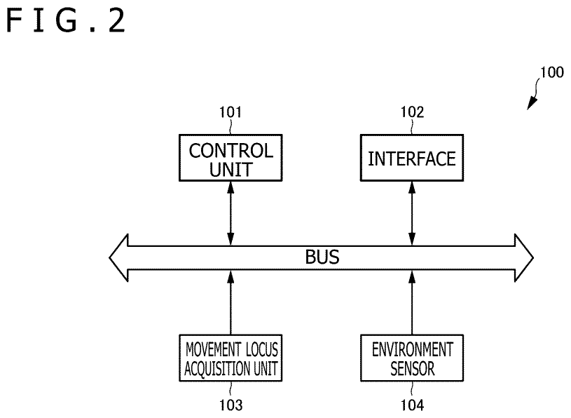

A configuration of the sensor apparatus 100 is described with reference to FIG. 2. The sensor apparatus 100 includes a control unit 101, an interface 102, a movement locus acquisition unit 103, and an environment sensor 104.

The control unit 101 includes a CPU (Central Processing Unit), a RAM (Random Access Memory), a ROM (Read Only Memory), and so forth. The CPU executes various processes in accordance with a program stored in the ROM, to perform issuance of a command and thereby perform control of the entirety and the components of the sensor apparatus 100.

The interface 102 is an interface between an apparatus such as the information processing apparatus 200 and the Internet or the like. The interface 102 can include a wired or wireless communication interface. Further, more particularly, the wired or wireless communication interface may include cellular communication such as 3TTE, Wi-Fi, Bluetooth (registered trademark), NFC (Near Field Communication), Ethernet (registered trademark), HDMI (registered trademark) (High-Definition Multimedia Interface), USB (Universal Serial Bus), or the like.

The movement locus acquisition unit 103 acquires movement locus data of the moving body, and the movement locus data is acquired as coordinate time series data. As the movement locus acquisition unit 103, for example, a PDR (Pedestrian Dead-Reckoning) module, a GPS (Global Positioning System) module, a camera, a LiDAR (Light Detection and Ranging, Laser Imaging Detection and Ranging), a millimeter-wave positioning sensor, and so forth are available. Also a monitor camera independent of the sensor apparatus 100 may be adopted as an apparatus for movement locus acquisition.

The environment sensor 104 acquires environment data that is data relating to an environment of the surroundings of the moving body. For example, as the environment sensor 104, a ToF (Time Of Flight) sensor, a LiDAR, a millimeter-wave positioning sensor, Bluetooth (registered trademark), a barometric pressure sensor, and so forth are available. In the ToF sensor, the LiDAR, and the millimeter-wave positioning sensor, data regarding a distance from a physical body that is present in the surroundings of the moving body to the moving body can be obtained as the environment data. Further, in Bluetooth (registered trademark), in a case where a physical body has a device having a Bluetooth (registered trademark) function, it is recognized how far the device is. Further, the barometric pressure sensor detects a wind pressure or the like, for example, when a large physical body passes the proximity of the moving body.

For example, a configuration in which a GPS module and a ToF sensor are connected to a Raspberry Pi, movement locus data and environment data obtained from them are transferred to a smartphone or the like by Bluetooth (registered trademark) , and then the pieces of data are transmitted from the smartphone to the information processing apparatus 200 is also possible.

The sensor apparatus 100 is configured in such a manner as described above. The sensor apparatus 100 transmits the movement locus data acquired by the movement locus acquisition unit 103 and the environment data acquired by the environment sensor 104 to the information processing apparatus 200.

The sensor apparatus 100 may be configured as a single apparatus, or a device to be used by a person as a moving body, for example, a smartphone, a tablet terminal, a wearable device, a personal computer, or the like, may be configured in such a manner as to include a function of the sensor apparatus 100.

Further, a sensor apparatus including a function of the movement locus acquisition unit 103 and a sensor apparatus including a function of the environment sensor 104 may be configured as apparatuses separate from each other. For example, possible configurations are a smartphone including a function of the movement locus acquisition unit 103, a wearable device including a function of the environment sensor 104, and the like.

### [1-3. Configuration of Information Processing Apparatus 200]

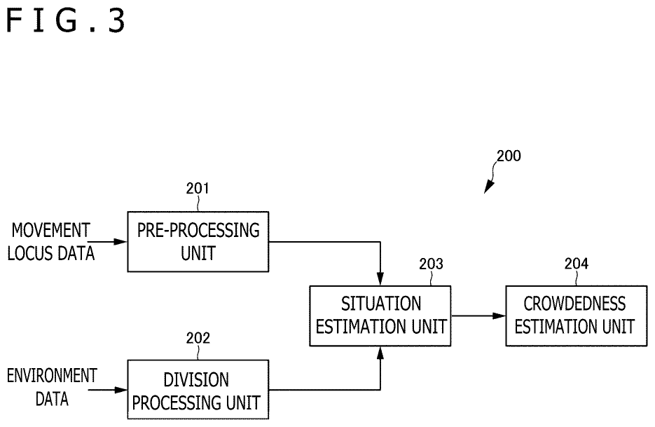

Now, a configuration of the information processing apparatus 200 is described with reference to FIG. 3. The information processing apparatus 200 includes a pre-processing unit 201, a division processing unit 202, a situation estimation unit 203, and a crowdedness estimation unit 204.

The pre-processing unit 201 performs a pre-process for movement locus data to convert the movement locus data into time series data of a velocity vector. By the conversion, a moving direction and a moving velocity of the moving body itself are known. The movement locus data converted into time series data of a velocity vector by the pre-process is inputted to the situation estimation unit 203.

The division processing unit 202 divides environment data by using a time window of a fixed period of time. The divided environment data is inputted to the situation estimation unit 203.

The situation estimation unit 203 estimates, on the basis of the movement locus data and the environment data, a situation of the surroundings of the moving body by machine learning such as a CNN (Convolutional Neural Network), for example. The situation of the surroundings is, for example, whether a physical body is present in the surroundings of the moving body, whether the physical body that is present is a person or a thing, the number of physical bodies that are present, whether the physical body that is present is moving, whether the physical body that is present is moving in such a manner that the physical body and the moving body pass each other, whether the physical body that is present is moving in such a manner as to overtake the moving body, and so forth.

In a learning stage for situation estimation, movement locus data and environment data, an image indicative of a state of a person and a physical body, a type, the number, and a label of amount of physical bodies, and so forth acquired in advance are inputted as correct answer data to the situation estimation unit 203 to perform learning.

The crowdedness estimation unit 204 estimates, on the basis of a situation estimation result of the situation estimation unit 203, whether or not the surroundings of the moving body are crowded with people. The crowdedness estimation unit 204 estimates whether or not the surroundings of the moving body are crowded, by machine learning such as a CNN, for example. The crowdedness estimation unit 204 outputs, for example, an estimation result of any one of “crowded” and “not crowded (deserted).”

In a learning stage for crowdedness estimation, an image indicative of a crowded situation, an image indicative of a non-crowded situation, and so forth that are acquired in advance are inputted to the crowdedness estimation unit 204 to perform learning.

It is to be noted that it is also possible for the crowdedness estimation unit 204 to estimate, in a case where the number of people estimated, in the situation estimation result, to be present in the surroundings of the moving body is equal to or greater than a predetermined number, that the surroundings of the moving body are crowded.

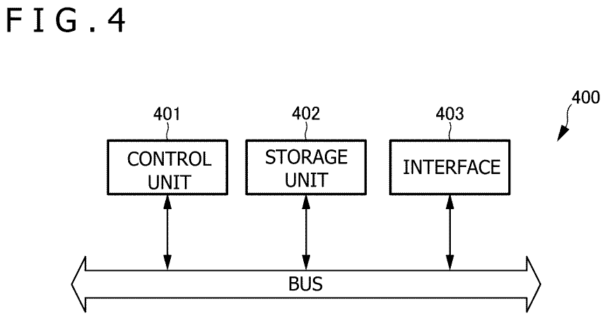

The information processing apparatus 200 is configured in such a manner as described above. The information processing apparatus 200 operates, for example, in a server apparatus 400 depicted in FIG. 4. The server apparatus 400 includes at least a control unit 401, a storage unit 402, and an interface 403.

The control unit 401 includes a CPU, a RAM, a ROM and, so forth. The CPU executes various processes in accordance with a program stored in the ROM, to perform issuance of a command and thereby perform control of the entirety and the components of the server apparatus 400.

The storage unit 402 is a mass storage medium such as a hard disk or a flash memory, for example.

The interface 403 is an interface that performs communication with the sensor apparatus 100, the sensor apparatus 100, a terminal apparatus 500, the Internet, and so forth and is similar to that provided in the sensor apparatus 100. Further, in a case where the server apparatus 400 and the information processing apparatus 200 are connected to each other in hardware, the interface 403 can include connection terminals between the apparatuses, buses in the apparatuses, and so forth. Further, in a case where the server apparatus 400 and the information processing apparatus 200 are implemented in such a manner as to be decentralized in multiple apparatuses, the interface 403 can include interfaces of different types for the individual apparatuses. For example, the interface 403 may include both a communication interface and an interface in the apparatus. Further, in a case where the server apparatus 400 and the information processing apparatus 200 are at least partly implemented by the same apparatus, the interface 403 can include a bus in the apparatus, data reference in a program module, and so forth.

The information processing apparatus 200 may be implemented by a process by the control unit 401 of the server apparatus 400. Further, the server apparatus 400 may be configured in such a manner as to have functions as the information processing apparatus 200 by execution of a program. In a case where the information processing apparatus 200 is implemented by a program, the program may be installed in the server apparatus 400 in advance or may be downloaded or distributed as a storage medium such that a user himself/herself may install the program. It is to be noted that the information processing apparatus 200 may operate not only in the server apparatus 400 but also in a smartphone, a tablet terminal, a wearable device, a personal computer, or the like.

### [1-4. Configuration of Estimation Result Processing Apparatus 300]

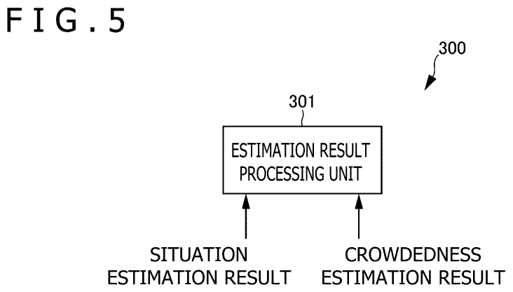

Now, a configuration of the estimation result processing apparatus 300 is described with reference to FIG. 5. The estimation result processing apparatus 300 includes an estimation result processing unit 301.

The estimation result processing unit 301 performs a predetermined process for both or one of a situation estimation result and a crowdedness estimation result transmitted thereto from the information processing apparatus 200. The predetermined process is to present the situation estimation result and/or the crowdedness estimation result to the user by displaying them/it, to use the situation estimation result and/or the crowdedness estimation result in an application (a map application, a navigation application, or the like), to transmit the situation estimation result and/or the crowdedness estimation result to a cloud or the like such that the situation estimation result and the crowdedness estimation result of multiple moving bodies are collected and integrated for distribution, and so forth.

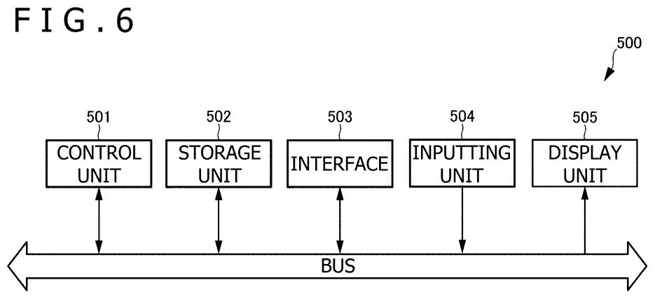

The estimation result processing apparatus 300 is configured in such a manner as described above. The information processing apparatus 200 operates, for example, in a terminal apparatus 500 depicted in FIG. 6. The terminal apparatus 500 includes at least a control unit 501, a storage unit 502, an interface 503, an inputting unit 504, and a display unit 505.

The control unit 501, the storage unit 502, and the interface 503 are similar to those provided in the sensor apparatus 100 and the server apparatus 400.

The inputting unit 504 is provided for allowing the user to input various instructions and so forth to the terminal apparatus 500. If the user performs an inputting operation for the inputting unit 504, then a control signal according to the input is generated and supplied to the control unit 501. Then, the control unit 501 performs various processes corresponding to the control signal. The inputting unit 504 includes, in addition to a physical button, a touch panel, a speech input by speech recognition, a gesture input by human body recognition, and so forth.

The display unit 505 is a display device such as a display that displays a situation estimation result and a crowdedness estimation result obtained by the information processing apparatus 200, information obtained from the estimation results, a GUI (Graphical User Interface), and so forth.

As the terminal apparatus 500, for example, a smartphone, a tablet terminal, a wearable device, a personal computer, and so forth are available.

The estimation result processing apparatus 300 may be implemented by a process by the control unit 501 of the terminal apparatus 500. Further, the terminal apparatus 500 may be configured in such a manner as to function as the estimation result processing apparatus 300 by execution of a program. In a case where the estimation result processing apparatus 300 is implemented by a program, the program may be installed into the terminal apparatus 500 in advance or may be downloaded or distributed as a recording medium or the like such that the user himself/herself installs the program.

It is to be noted that the sensor apparatus 100, the information processing apparatus 200, and the estimation result processing apparatus 300 may be configured as one apparatus or may operate in one apparatus. Otherwise, the sensor apparatus 100 and the information processing apparatus 200 may be configured as one apparatus or operate in one apparatus. In this case, the sensor apparatus 100 and the information processing apparatus 200 operate in the terminal apparatus 500, and the estimation result processing apparatus 300 operates in a different terminal apparatus. Meanwhile, the sensor apparatus 100 and the estimation result processing apparatus 300 may be configured as one apparatus or may operate in one apparatus. In this case, for example, the sensor apparatus 100 and the estimation result processing apparatus 300 operate in the terminal apparatus 500, and the information processing apparatus 200 operates in the server apparatus 400. Furthermore, the information processing apparatus 200 and the estimation result processing apparatus 300 may be configured as one apparatus or may operate in one apparatus. In this case, for example, the information processing apparatus 200 and the estimation result processing apparatus 300 operate in the server apparatus 400 and the terminal apparatus 500.

### [1-5. Process by Information Processing Apparatus 200]

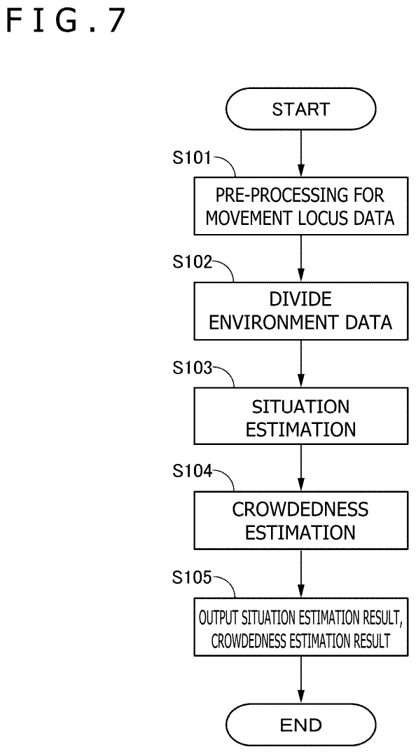

Now, a process by the information processing apparatus 200 is described with reference to FIG. 7. Here, description is given assuming that a person who is a moving body has the sensor apparatus 100 mounted on his/her body and the movement locus acquisition unit 103 is a PDR while the environment sensor 104 is a ToF sensor.

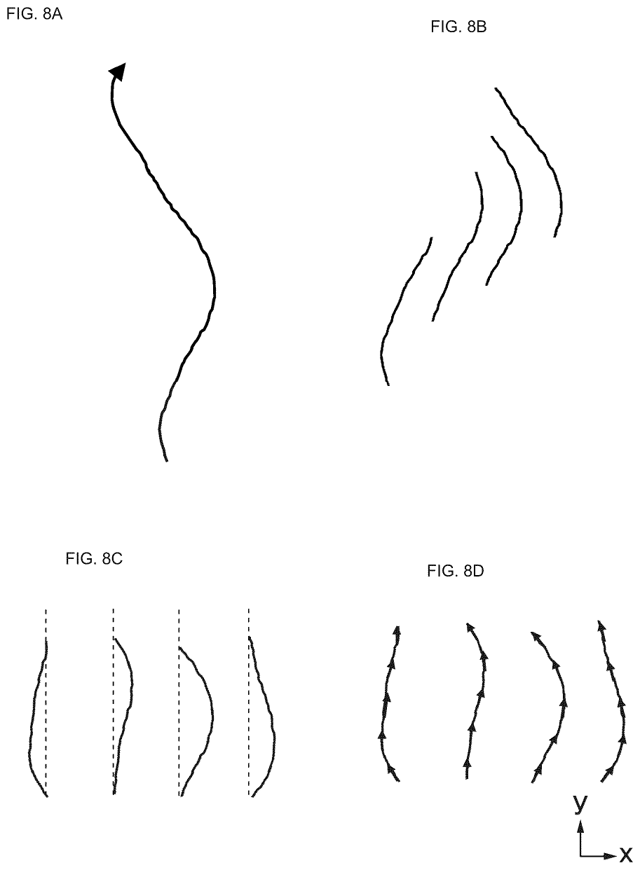

First, in step S101, the pre-processing unit 201 performs a pre-process for movement locus data. In the pre-process, for example, movement locus data depicted in FIG. 8A is divided into multiple pieces of movement locus data with use of time windows of a fixed period of time such that they partly overlap with each other as depicted in FIG. 8B.

Then, as depicted in FIG. 8C, for the multiple pieces of movement locus data generated by the division, a rotation process is performed such that lines interconnecting a start point and an end point of the movement locus are directed in the same direction by a rotation matrix.

Next, as depicted in FIG. 8D, the pieces of movement locus data are individually converted into time series data of a velocity vector (Vx, Vy). The velocity vectors obtained by the conversion are individually inputted to the situation estimation unit 203. It is to be noted that, in place of the velocity vectors or in addition to the velocity vectors, an FFT (Fast Fourier Transform) result of the movement locus data may be inputted to the situation estimation unit 203.

Subsequently, in step S102, environment data is divided with use of a time window of a fixed period of time. The time window of a fixed period of time may have an interval of time same as that in the division of the movement locus or have a different interval of time. The pieces of divided environment data are inputted to the situation estimation unit 203.

It is to be noted that step S101 and step S102 may be performed in the reverse order or may be performed substantially simultaneously.

Then, in step S103, the situation estimation unit 203 performs a situation estimation process on the basis of the environment data and the movement locus data that has been converted into velocity vectors. The situation estimation unit 203 performs situation estimation for each of the multiple divided velocity vectors. A situation estimation result is inputted to the crowdedness estimation unit 204.

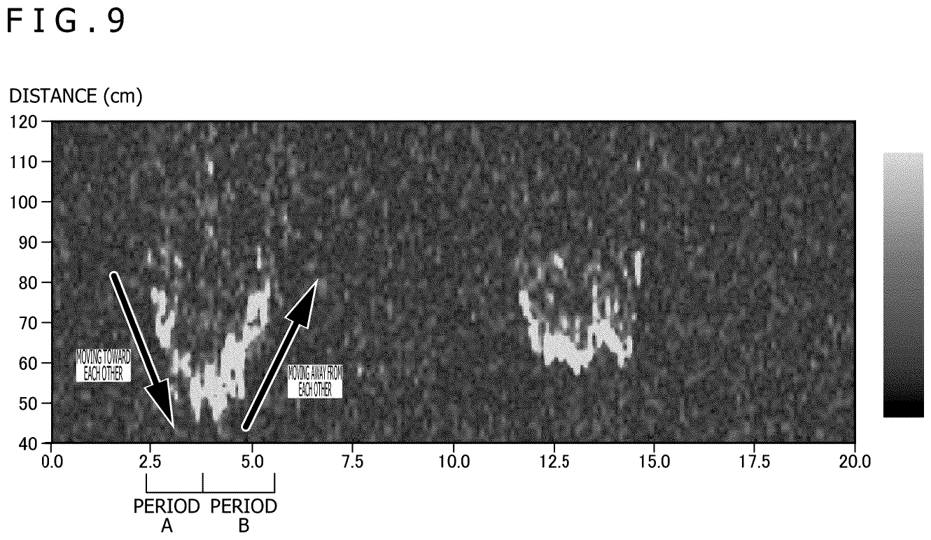

Here, the situation estimation process by the situation estimation unit 203 is described. By the ToF sensor, such ToF data as depicted in FIG. 9 can be obtained. In a graph depicted in FIG. 9, the axis of abscissa represents time, the axis of ordinate represents the distance between a moving body and a physical body, and a gray scale indicates a reflection intensity of reflected light in ToF.

During a period A in the graph of FIG. 9, it can be recognized that, when the physical body moves to a distance of approximately 80 cm toward the moving body, reflected light begins to be detected and, since the distance between the moving body and the physical body thereafter decreases as time passes, the moving body and the physical body gradually move toward each other. In contrast, during a period B, since the distance between the moving body and the physical body increases as time passes, it can be recognized that the moving body and the physical body gradually move away from each other.

In a state in which the moving body is not moving (stays at the place), the TOF data alone is insufficient to distinguish a case in which the physical body and the moving body pass each other and another case in which the physical body overtakes the moving body from each other. This is because, in a case where it is assumed that the moving velocity of the physical body in the case where the physical body and a moving body pass each other and the moving velocity of the physical body in the case where the physical body overtakes the moving body are equal to each other, the physical body moves toward the moving body at an equal velocity and moves away from the moving body at an equal velocity irrespective of whether the physical body and the moving body pass each other or the physical body overtakes the moving body.

However, the addition of the velocity vector of the movement of the moving body as a factor in situation estimation in a CNN makes it possible to make a distinction between a case in which the moving body and the physical body pass each other and a case in which the physical body overtakes the moving body. In a case where the moving body that is moving and the physical body that is moving pass each other, since the moving body is moving in a direction toward the physical body and the physical body is moving in a direction toward the moving body, the relative velocity of the physical body relative to the moving body is high in comparison with that in a case where the physical body overtakes the moving body. On the other hand, in a case where the physical body that is moving overtakes the moving body that is moving, since the physical body and the moving body are proceeding in the same direction, the relative velocity of the physical body relative to the moving body is low in comparison with that in a case where the physical body and the moving body pass each other. In such a manner, whether the physical body and the moving body pass each other or the physical body overtakes the moving body can be distinguished from each other on the basis of the relative velocity of the physical body relative to the moving body.

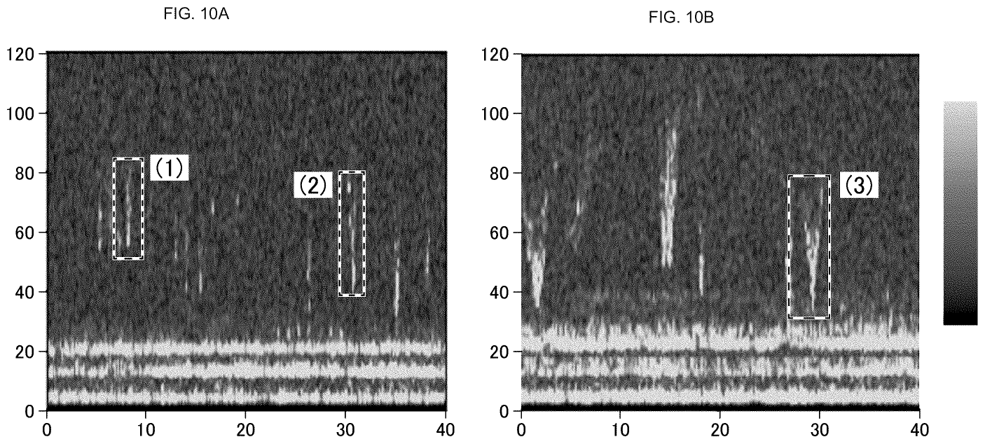

Therefore, in the present technology, with use of time series data of the velocity vector obtained by conversion of movement locus data and ToF data that is environment data, such responses (data indicative of a relation between the distance between a moving body and a physical body and the time) as depicted in FIGS. 10, 12, and 13 are obtained. In the graphs depicted in FIGS. 10, 12, and 13, the axis of abscissa represents time, the axis of ordinate represents the distance between a moving body and a physical body, and the gray level in the graphs indicates a reflection intensity of reflected light in ToF.

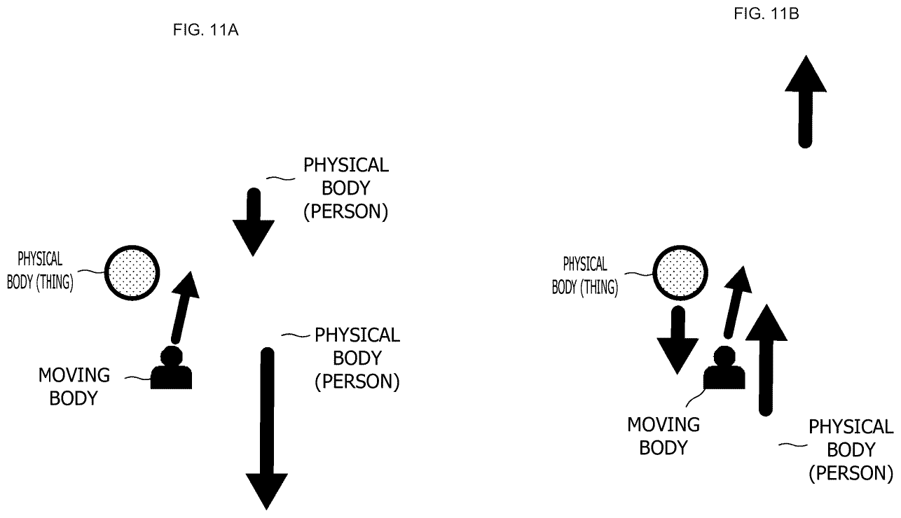

Responses (1) and (2) in the graph of FIG. 10A are examples of a linear response result. This response result indicates such a change of the distance between the moving body and the physical body that the moving body and the physical body move toward and away from each other in a short period of time equal to or shorter than a predetermined period of time. From this response result, it can be estimated that the relative velocity of the physical body relative to the moving body is high in comparison with a case where the physical body overtakes the moving body and that the physical body (for example, a person) is moving in such a manner that the physical body and the moving body pass each other as depicted in FIG. 11A.

Meanwhile, a response (3) in the graph of FIG. 10B is an example of a substantially V-shaped response result. This response result indicates such a change of the distance between the moving body and the physical body that the physical body moves toward the moving body in a period of time equal to or longer than the predetermined period of time more slowly than in the case of the linear response result of FIG. 10A and moves away from the moving body more slowly. From this response result, it can be estimated that the relative velocity of the physical body relative to the moving body is low in comparison with a case where the physical body and the moving body pass each other and that the physical body (for example, a person) is moving in such a manner as to overtake the moving body as depicted in FIG. 11B.

In regard to whether the relative velocity is high or low, for example, the relative velocity is compared with a predetermined reference velocity, and in a case where the relative velocity is equal to or higher than the predetermined reference velocity, it can be estimated that the physical body is moving in such a manner that the physical body and the moving body pass each other, but in a case where the relative velocity is equal to or lower than the predetermined reference velocity, it can be estimated that the physical body is moving in such a manner as to overtake the moving body.

It is to be noted that passing each other and overtaking can be distinguished from each other also on the basis of a response pattern (including a response shape) appearing on the graph. The linear response depicted in FIG. 10A can be distinguished as passing each other from the fact that the moving body and the physical body first move toward each other and then move away from each other in a short period of time. The substantially V-shaped response depicted in FIG. 10B can be distinguished as overtaking from the fact that the physical body slowly moves toward the moving body and slowly moves away from the moving body.

By adding the velocity vector of the movement of the moving body as a factor of estimation in the CNN, a distinction between the case of passing each other and the case of overtaking becomes possible.

Further, in both the case in which the physical body is moving and the case in which the physical body is stationary, as the moving body moves toward the physical body, the distance between the moving body and the physical body decreases, and as the moving body moves away from the physical body, the distance between the moving body and the stationary physical body increases. In particular, since the distance between the moving body and the physical body changes in both the case in which the physical body is moving and the case in which the physical body is stationary, only from ToF data, it cannot be distinguished whether the physical body is stationary or moving.

However, by adding the velocity vector of the movement of the moving body as a factor of situation estimation in the CNN, it becomes possible to distinguish whether the physical body is moving or is stationary. In a case where the moving velocity of the moving body calculated from an amount of change of the distance between the moving body and the physical body in a period of time and the period of time and the velocity in the velocity vector of the moving body converted from the movement locus data are equal or substantially equal to each other, it can be estimated that the physical body is stationary as depicted in FIG. 11A. On the other hand, in a case where the moving velocity of the moving body calculated from an amount of change of the distance between the moving body and the physical body in a period of time and the period of time and the velocity in the velocity vector of the moving body converted from the movement locus data are not equal or not substantially equal to each other, it can be estimated that the physical body is moving as depicted in FIG. 11B.

Further, in a case where a response indicative of a change of the distance between the moving body and the physical body coincides with a pattern (a shape, a reflection intensity, and so forth) associated with a predetermined thing in advance, it can be estimated that the physical body is a thing.

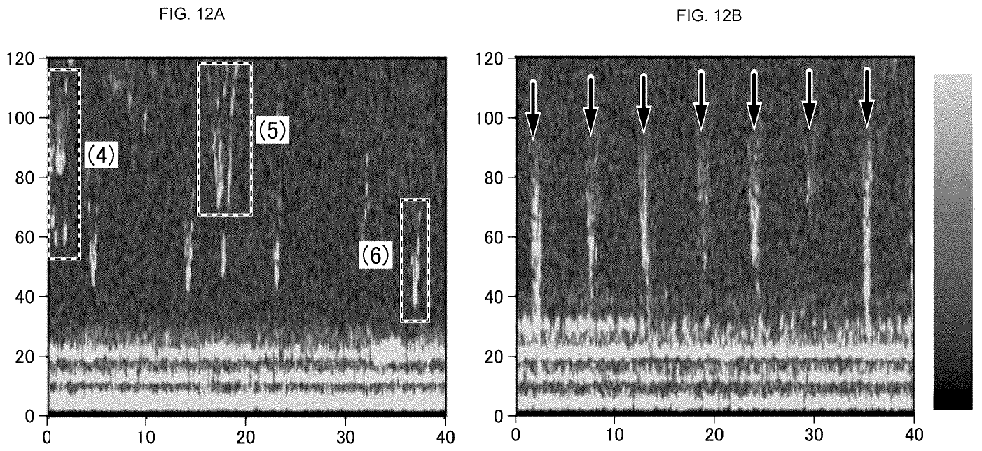

For example, a response (4) in the graph of FIG. 12A indicates that it includes a strong response. From such a response result having a reflection intensity equal to or higher than the predetermined reflection intensity as just described, it can be estimated that, for example, a physical body made of metal such as a signboard is present in the surroundings of the moving body.

Further, a response (5) in the graph of FIG. 12A depicts a response result of a trapezoidal shape. A response of such a trapezoidal shape as just described is a response in a case where the period of time during which the moving body and the physical body are close to each other is long and a physical body that is made of metal and that has a long dimension such as a truck is present. Therefore, if such a trapezoidal response as just described and a physical body having a long dimension and made of metal such as a truck are associated with each other, then it can be estimated from the response that the physical body is not a person but a thing such as a truck. It is to be noted that situation estimation may be performed using, in addition to such a shape of a response as described above, a change of the distance between the moving body and the physical body and the velocity of the moving body and the physical body.

Meanwhile, since a response (6) in the graph of FIG. 12A indicates response time of a medium degree between those upon passing each other and upon overtaking, it can be estimated that such a physical body as, for example, a utility pole is present.

Further, in the graph of FIG. 12B, multiple detection results on straight lines are lined up at fixed intervals of time in a time axis direction as indicated by multiple arrow marks in FIG. 12B. The response results indicate such a change of the distance and a change of the relative velocity between the moving body and the physical body that the moving body and the physical body successively move toward each other and then move away from each other at fixed intervals of time. From the response results, it can be estimated that, for example, the physical body is not a person but a stationary thing and things disposed at fixed distances such as roadside trees are present in the surroundings of the moving body.

In such a manner, by adding the velocity vector of the movement of the moving body as a factor of situation estimation in the CNN, it becomes possible to distinguish whether a physical body that is present in the surroundings of a moving body is moving or is stationary, on the basis of the relative velocity of the physical body relative to the moving body.

Further, by obtaining ToF data for each physical body and identifying a pattern of ToF data for each physical body, it becomes possible to distinguish various physical bodies such as a signboard, a utility pole, a roadside tree, a wall, and a traveling bicycle or automobile.

In such a manner, according to the present technology, it is possible to distinguish whether a physical body that is present in the surroundings of a moving body is a person or a thing, on the basis of both or one of the velocity of the moving body and the physical body and the distance between the moving body and the physical body. Further, it can be distinguished whether the physical body is moving or stationary. It is also possible to distinguish whether the physical body is moving in such a manner that the physical body and the moving body pass each other or is moving in such a manner as to overtake the moving body.

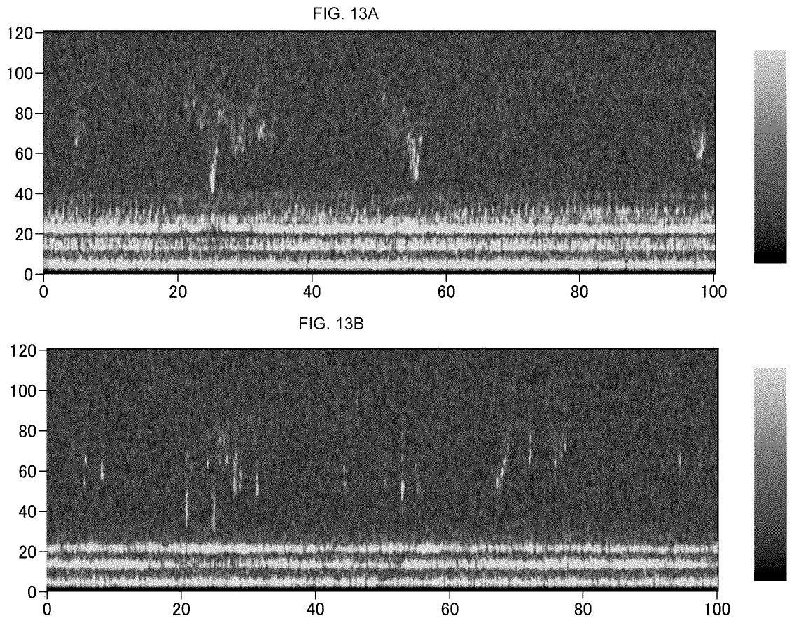

FIG. 13A depicts an example of data indicative of a relation between time and the distance between the moving body and the physical body obtained from the movement locus data and the ToF data acquired by the sensor apparatus 100 mounted on the left side of the body of a person that is the moving body. Meanwhile, FIG. 13B depicts an example of data indicative of a relation between time and the distance between the moving body and the physical body obtained from the movement locus data and the ToF data acquired by the sensor apparatus 100 mounted on the right side of the body of a person who is the moving body.

By mounting the sensor apparatus 100 on both the left side and the right side of the moving body in such a manner, it is also possible to distinguish such a situation that, for example, on the left side of the moving body, a person overtakes the moving body while, on the right side of the moving body, another person and the moving body pass each other. By this, it is possible to estimate a situation in the surroundings of the moving body more particularly. It is to be noted that it is also possible to mount the sensor apparatus 100 on the front side and the rear side of the moving body to acquire data, and it is also possible to mount the sensor apparatus 100 on the upper side and the lower side of the moving body to acquire data.

In a case where any one of the movement locus data and the environment data has a partial defect, it is sufficient if values available before and after the defect are used, if an interpolation value between the values available before and after the defect is used, or if only data free from the defect from between the movement locus data and the environment data is used, for example.

It is to be noted that, although the foregoing description is given taking a case in which the physical body overtakes the moving body as an example, also in a case where the moving body overtakes the physical body, a similar distinction is possible.

Description is given with reference to the flow chart of FIG. 7 again. In next step S104, the crowdedness estimation unit 204 performs crowdedness estimation on the basis of the situation estimation result. The crowdedness estimation unit 204 outputs any one of estimation results, for example, “crowded” or “not crowded (deserted).”

As one method of crowdedness estimation according to the conventional technology, available is a method for estimating whether or not the surroundings of the moving body are crowded, on the basis of whether or not the movement locus of the moving body is meandering. In a case where the movement locus of the moving body meanders, since the moving body is walking avoiding people, it is estimated that the surroundings of the moving body are crowded.

However, the method described above has a problem in that, even if many people are present in the surroundings of the moving body, in a case where most of the people are moving in a direction same as that of the moving body, since the movement locus of the moving body does not meander, it is estimated that the surroundings of the moving body are not crowded despite that many people are present in the surroundings of the moving body.

In the present technology, as described above, it is possible to distinguish whether a physical body that is present in the surroundings of a moving body is a person or a thing, distinguish a moving direction of people who are present in the surroundings of the moving body, and estimate a situation in the surroundings of the moving body.

For example, in a case where the number of physical bodies that are present in the surroundings of a moving body is equal to or greater than a predetermined number and besides the physical bodies are people, it is possible to estimate that the surroundings of the moving body are crowded, even if the movement locus of the moving body is not meandering.

Further, even in a case where the movement locus of the moving body meanders because, for example, an obstacle is present in the surroundings of the moving body, in a case where the number of people in the surroundings of the moving body is equal to or smaller than a predetermined number, it can be estimated that the surroundings of the moving body are not crowded.

In addition, even in a case where the movement locus of the moving body is not meandering, in a case where the number of people who are present in the surroundings of the moving body is equal to or greater than a predetermined number, it can be estimated that the surroundings of the moving body are crowded.

Moreover, in a case where the situation in the surroundings of the moving body is crowded, the walking velocity of the moving body becomes slow in order to avoid the surrounding people. Also the walking velocity obtained from the movement locus data can be made an estimation factor of whether or not the surroundings of the moving body are crowded.

Both or any one of a situation estimation result by the situation estimation unit 203 and a crowdedness estimation result by the crowdedness estimation unit 204 is transmitted to the estimation result processing apparatus 300.

The estimation result processing apparatus 300 uses the received situation estimation result and crowdedness estimation result in various methods. For example, they are displayed on the display unit 505 of the terminal apparatus 500 and are thereby presented to the user, used in an application (a map application, a navigation application, or the like), transmitted to a cloud or the like such that situation estimation results and crowdedness estimation results of multiple moving bodies are collected and integrated for distribution, or used in other methods. It is also possible to perform provision of traffic volume-crowdedness information, people flow analysis, and so forth with use of the situation estimation result and the crowdedness estimation result.

It is to be noted that the information processing apparatus 200 may not perform crowdedness estimation but transmit therefrom only the situation estimation result to the estimation result processing apparatus 300 such that the estimation result processing apparatus 300 performs crowdedness estimation.

The present technology is configured in such a manner as described above. According to the present technology, a situation of a physical body in the surroundings of a moving body can be estimated with high accuracy. By this, also estimation of whether or not the surroundings of the moving body are crowded can be performed with high accuracy.

Further, with use of a situation estimation result and a crowdedness estimation result that are obtained by the present technology and machine learning such as a CNN, traffic volume estimation, estimation of the quantity of obstacles on a path, estimation of the number of pedestrians, estimation of the direction and the velocity of a flow of pedestrians, a degree (randomness) in which a direction in which people walk in the surroundings or the velocity with which people walk in the surroundings is not uniform, crowdedness prediction, prediction of arrival time, estimation of the ease of walking, specification of places prone to be crowded, people flow analysis, estimation of the number of people in a line, and so forth can also be performed. Further, by using estimation results of them and the estimation results, it is also possible to present to a user a safe route in which the number of people is small, the flow to a destination is smooth, and besides the traffic volume is small. In particular, the estimation results can be used for route induction between stations and a fireworks display venue in fireworks display or induction to a vacant place in the venue, route induction to a venue for a live event or the like or proposal of a route in the venue, and so forth.

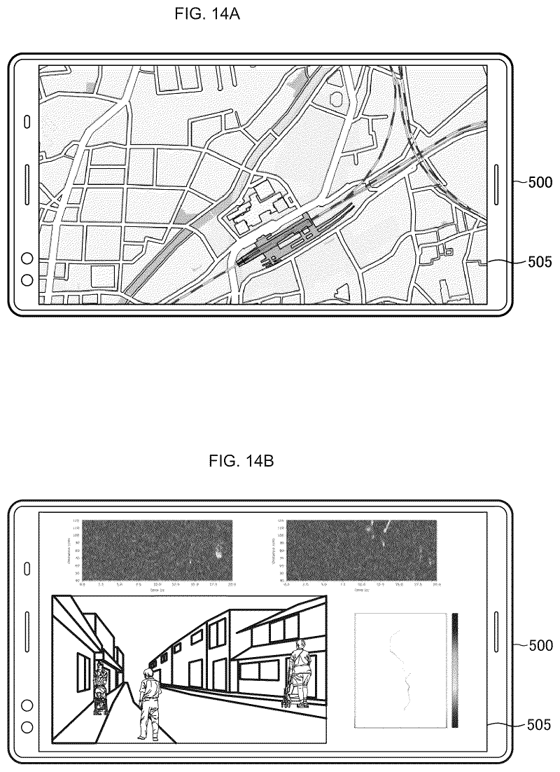

FIG. 14 depicts an example in which a crowdedness estimation result is displayed in a superimposed relation on a map displayed by a map application on the display unit 505 of the terminal apparatus 500. As depicted in FIG. 14A, roads estimated to be crowded and roads estimated not to be crowded are individually indicated by coloring or the like on the map. Further, as depicted in FIG. 4B, if the user designates a road, then ToF data at present or in the past in regard to the designated road, an image indicating a state in the same time zone at present or in the past, or the like may be displayed.

### [1-6. Experiment Result]

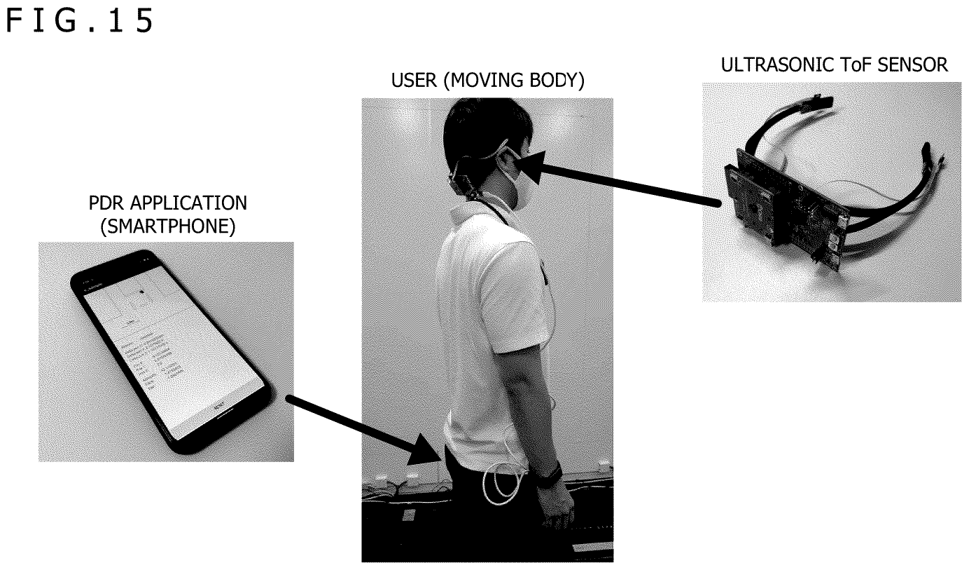

Now, a result of an experiment actually performed using the present technology is described with reference to FIGS. 15 to 19. In this experiment, movement locus data was acquired by a PDR application installed in a smartphone, as depicted in FIG. 15. The smartphone was placed into a pocket of clothes worn by a user (person) as a moving body. The movement locus data acquisition of the PDR application was performed approximately by one sample/second.

Further, in this experiment, ToF data as environment data was acquired by an ultrasonic ToF sensor. The ultrasonic ToF sensor was mounted on both of the left and right ears of the user (2 ch in total). The ultrasonic ToF sensor performed acquisition of data by 10 samples/second, and the measurement range was 40 to 120 cm. The PDR application and the ultrasonic ToF sensor correspond to the sensor apparatus 100.

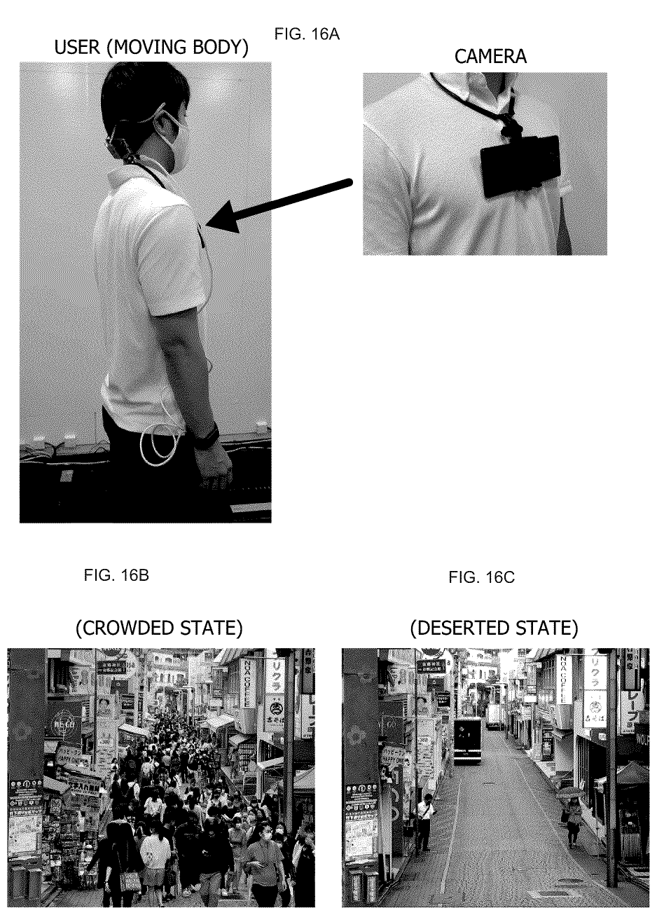

Further, as depicted in FIG. 16A, the user wore a camera for capturing an image in front of the user, in order to perform comparison between an actual situation in the surroundings of the user and a crowdedness estimation result. By the camera, images of such situations in the surroundings of the user when movement locus data and ToF data as depicted in FIGS. 16B and 16C were acquired were captured. FIG. 16B is an image exemplifying a state in which the surroundings of the user are crowded, and FIG. 16C is an image exemplifying a state in which the surroundings of the user are deserted.

The movement locus data and the ToF data were acquired in the crowded state and the deserted state at totaling eight places of Ameyoko, Uechun (Ueno Central Street Shopping District), Shinagawa Station (concourse outside the ticket gate), Takeshita Street, Kachidoki (Kachidoki Station, in front of the Triton Bridge), Yokohama Station (underground central passage), Yushima (one of the prefectural road 452, western passage), and Sony Corporation Head Office Building 8F while the user travelled back and forth for a long period of time on the road (including a road on a street and a passage in a facility) (except a U-turn portion in back and forth travel).

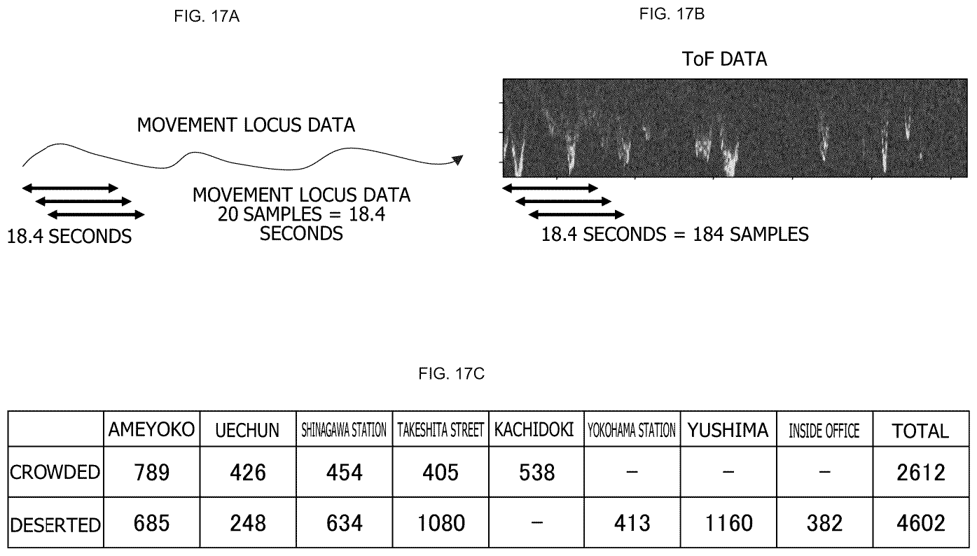

Then, the acquired successive pieces of data of the movement locus data and the ToF data were divided using a time window of a fixed period of time (18.4 seconds) as depicted in FIGS. 17A and 17B. As a result, the pieces of movement locus data were divided into 20 samples, the pieces of ToF data were divided into 184 samples, and the numbers of pieces of data when the individual places were crowded and when the individual places were deserted were such as depicted in FIG. 17C. It is to be noted that the determination of crowdedness and desertedness at the places was performed by an experimenter on the basis of the state and the number of people in images captured by the camera worn by the user. As the ToF data, pieces of data (100 points per one sample) within 40 to 120 cm from the ultrasonic ToF sensor were used.

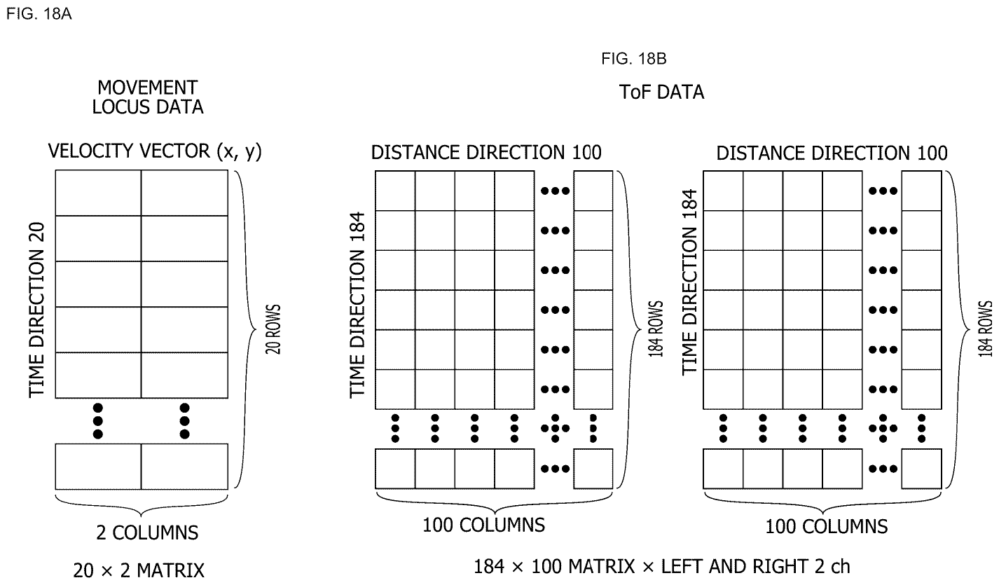

Then, such pieces of data as depicted in FIG. 18 were used for single time situation estimation and crowdedness estimation. As depicted in FIG. 18A, the movement locus data is data of a 20×2 matrix according to a time direction and the velocity vector (x, y). As depicted in FIG. 18B, the ToF data is data of a 184×100 matrix according to the time direction and a distance direction. It is to be noted that, since the ultrasonic ToF sensor is mounted on both of the left and right ears of the user, the ToF data is data of 2 ch.

By inputting such movement locus data and ToF data as described above to the situation estimation unit 203, the situation in the surroundings of the user was estimated. Further, from a result of the situation estimation, it was estimated by the crowdedness estimation unit 204 whether or not the surroundings of the user were crowded. It is to be noted that the movement locus data and the ToF data depicted in FIG. 18 whose numbers of pieces of data are those depicted in FIG. 17 exist.

The crowdedness estimation results obtained at the places in such a manner and the actual situation in the surroundings of the user determined by the experimenter from the images captured by the camera were compared with each other to calculate the correct answer rate of the crowdedness estimation results. For example, the correct answer rate is how much percentage of the 789 pieces of data that are the pieces of data at Ameyoko in the crowded state could be estimated as being crowded or how much percentage of 685 pieces of data that are the pieces of data at Ameyoko in the deserted state could be estimated as being deserted. It is to be noted that the calculation of the correct answer rate was performed at the four places of Ameyoko, Uechun, Shinagawa Station, and Takeshita Street at which pieces of data regarding both the crowded state and the deserted state were available. However, the pieces of data at the other four places (Kachidoki, Yokohama Station, Yushima, and Sony Corporation Head Office Building) were also used for learning of a CNN by the situation estimation unit 203 and the crowdedness estimation unit 204.

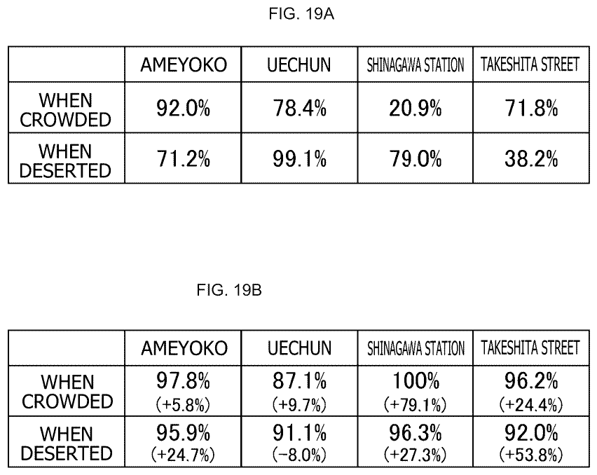

The table of FIG. 19A indicates correct answer rates of the estimation results obtained by estimating the crowdedness and the desertedness only with the movement locus data at Ameyoko, Uechun, Shinagawa Station, and Takeshita Street and comparing estimation results with actual states at the places.

For example, when the Shinagawa Station is crowded, even if the number of people is great, the people are moving in the same direction and there is a flow in movement of the people, and therefore, the movement does not meander, so that the correct answer rate is low by the conventional estimation method.

Further, for example, when the Takeshita Street is deserted, many such things as signboards of shops are present despite that the number of people is small, the things are misidentified as people, and it is estimated that the place is crowded, resulting in the low correct answer rate.

The table of FIG. 19B indicates correct answer rates of estimation results obtained by estimating the crowdedness and desertedness on particular roads at Ameyoko, Uechun, Shinagawa Station, and Takeshita Street with use of the present technology and comparing estimation results against actual states of the roads. At substantially all places, the correct answer rate was high in comparison with those where the crowdedness and the desertedness were estimated only from the movement locus data. Consequently, it was found that, with the present technology, the crowdedness can be estimated with a high system in comparison with the conventional technology.

Since the present technology is capable of distinguishing whether a physical body that is present in the surroundings of a moving body is a person, even in a case where people proceed in the same direction and a flow is generated by the movement of the people as in a case in which the Shinagawa Station is crowded, it can be estimated that the surroundings of the moving body are crowded, with a high correct answer rate in comparison with that by the method of the conventional technology.

Further, since the present technology is capable of distinguishing whether a physical body that is present in the surroundings of a moving body is a thing, a situation in which, although there are a small number of people, there are many things as in a case when the Takeshita Street is deserted can be estimated as being deserted with a high correct answer rate in comparison with that by the method of the conventional technology.

### 4. Modification

Although the embodiment of the present technology has been described particularly, the present technology is not restricted to the embodiment described above, and various modifications based on the technical idea of the present technology are possible.

Although it has been described that, in the embodiment, the situation estimation unit 203 that performs situation estimation and the crowdedness estimation unit 204 that performs crowdedness estimation are processing units different from each other, both situation estimation and crowdedness estimation may be performed by a single processing unit by a CNN or the like.

The present technology can also adopt the following configurations.
(1)

An information processing apparatus including:
a situation estimation unit that estimates, on the basis of movement locus data indicative of a movement locus of a moving body and environment data indicative of an environment in surroundings of the moving body, a situation of a physical body in the surroundings of the moving body.
(2)

The information processing apparatus according to (1), in which
the situation estimation unit estimates a situation of the physical body in the surroundings of the moving body on the basis of both or any one of a velocity of the moving body and the physical body and a distance between the moving body and the physical body, the velocity and the distance being obtained from the movement locus data and the environment data.
(3)

The information processing apparatus according to (2), in which
the velocity of the moving body and the physical body includes a relative velocity of the physical body relative to the moving body.
(4)

The information processing apparatus according to (3), in which
the situation estimation unit distinguishes, on the basis of the relative velocity of the physical body relative to the moving body, whether the physical body is a person or a thing.
(5)

The information processing apparatus according to (4), in which,
in a case where such a change of the distance that the moving body and the physical body move toward each other and then move away from each other at fixed intervals of time occurs by multiple times, the situation estimation unit estimates that the physical body is a thing.
(6)

The information processing apparatus according to (4) or (5), in which,
in a case where a change of the distance coincides with a pattern associated with a predetermined thing in advance, the situation estimation unit estimates that the physical body is a thing.
(7)

The information processing apparatus according to (3), in which
the situation estimation unit distinguishes whether the physical body is moving or is stationary, on the basis of the relative velocity of the physical body relative to the moving body.
(8)

The information processing apparatus according to (7), in which
the situation estimation unit distinguishes, on the basis of the relative velocity of the physical body relative to the moving body, whether the physical body is moving in such a manner that the physical body and the moving body pass each other or is moving in such a manner as to overtake the moving body.
(9)

The information processing apparatus according to (8), in which,
in a case where the relative velocity of the physical body relative to the moving body is equal to or higher than a predetermined velocity, the situation estimation unit estimates that the physical body is moving in such a manner that the physical body and the moving body pass each other.
(10)

The information processing apparatus according to (8), in which,
in a case where the relative velocity of the physical body relative to the moving body is equal to or lower than a predetermined velocity, the situation estimation unit estimates that the physical body is moving in such a manner as to overtake the moving body.
(11)

The information processing apparatus according to (2), in which,
in a case where there is such a change of the distance that the physical body moves toward the moving body and then moves away from the moving body within a range equal to or shorter than a predetermined period of time, the situation estimation unit estimates that the physical body is moving in such a manner that the physical body and the moving body pass each other.
(12)

The information processing apparatus according to (2), in which,
in a case where there is such a change of the distance that the physical body moves toward the moving body and then moves away from the moving body within a range equal to or longer than a predetermined period of time, the situation estimation unit estimates that the physical body is moving in such a manner as to overtake the moving body.
(13)

The information processing apparatus according to (4), including:
a crowdedness estimation unit that estimates, on the basis of a situation estimation result by the situation estimation unit, whether or not the surroundings of the moving body are crowded with the persons.
(14)

The information processing apparatus according to (13), in which,
in a case where the number of the physical bodies distinguished as persons is equal to or greater than a predetermined number, the crowdedness estimation unit estimates that the surroundings of the moving body are crowded.
(15)

The information processing apparatus according to any one of (1) to (14), in which
the moving body includes a person.
(16)

The information processing apparatus according to any one of (1) to (15), in which
the environment data includes data regarding a distance between the moving body and the physical body.
(17)

An information processing method including:
estimating, on the basis of movement locus data indicative of a movement locus of a moving body and environment data indicative of an environment in surroundings of the moving body, a situation of a physical body in the surroundings of the moving body.
(18)

An information processing program for causing a computer to execute an information processing method including:
estimating, on the basis of movement locus data indicative of a movement locus of a moving body and environment data indicative of an environment in surroundings of the moving body, a situation of a physical body in the surroundings of the moving body.

### REFERENCE SIGNS LIST

200: Information processing apparatus
203: Situation estimation unit
204: Crowdedness estimation unit

1. An information processing apparatus comprising:
a situation estimation unit that estimates, on a basis of movement locus data indicative of a movement locus of a moving body and environment data indicative of an environment in surroundings of the moving body, a situation of a physical body in the surroundings of the moving body.

2. The information processing apparatus according to claim 1, wherein
the situation estimation unit estimates a situation of the physical body in the surroundings of the moving body on a basis of both or any one of a velocity of the moving body and the physical body and a distance between the moving body and the physical body, the velocity and the distance being obtained from the movement locus data and the environment data.

3. The information processing apparatus according to claim 2, wherein
the velocity of the moving body and the physical body includes a relative velocity of the physical body relative to the moving body.

4. The information processing apparatus according to claim 3, wherein
the situation estimation unit distinguishes, on a basis of the relative velocity of the physical body relative to the moving body, whether the physical body is a person or a thing.

5. The information processing apparatus according to claim 4, wherein,
in a case where such a change of the distance that the moving body and the physical body move toward each other and then move away from each other at fixed intervals of time occurs by multiple times, the situation estimation unit estimates that the physical body is a thing.

6. The information processing apparatus according to claim 4, wherein,
in a case where a change of the distance coincides with a pattern associated with a predetermined thing in advance, the situation estimation unit estimates that the physical body is a thing.

7. The information processing apparatus according to claim 3, wherein
the situation estimation unit distinguishes whether the physical body is moving or is stationary, on a basis of the relative velocity of the physical body relative to the moving body.

8. The information processing apparatus according to claim 7, wherein
the situation estimation unit distinguishes, on the basis of the relative velocity of the physical body relative to the moving body, whether the physical body is moving in such a manner that the physical body and the moving body pass each other or is moving in such a manner as to overtake the moving body.

9. The information processing apparatus according to claim 8, wherein,
in a case where the relative velocity of the physical body relative to the moving body is equal to or higher than a predetermined velocity, the situation estimation unit estimates that the physical body is moving in such a manner that the physical body and the moving body pass each other.

10. The information processing apparatus according to claim 8, wherein,
in a case where the relative velocity of the physical body relative to the moving body is equal to or lower than a predetermined velocity, the situation estimation unit estimates that the physical body is moving in such a manner as to overtake the moving body.

11. The information processing apparatus according to claim 2, wherein,
in a case where there is such a change of the distance that the physical body moves toward the moving body and then moves away from the moving body within a range equal to or shorter than a predetermined period of time, the situation estimation unit estimates that the physical body is moving in such a manner that the physical body and the moving body pass each other.

12. The information processing apparatus according to claim 2, wherein,
in a case where there is such a change of the distance that the physical body moves toward the moving body and then moves away from the moving body within a range equal to or longer than a predetermined period of time, the situation estimation unit estimates that the physical body is moving in such a manner as to overtake the moving body.

13. The information processing apparatus according to claim 4, comprising:
a crowdedness estimation unit that estimates, on a basis of a situation estimation result by the situation estimation unit, whether or not the surroundings of the moving body are crowded with the persons.

14. The information processing apparatus according to claim 13, wherein,
in a case where the number of the physical bodies distinguished as persons is equal to or greater than a predetermined number, the crowdedness estimation unit estimates that the surroundings of the moving body are crowded.

15. The information processing apparatus according to claim 1, wherein
the moving body includes a person.

16. The information processing apparatus according to claim 1, wherein
the environment data includes data regarding a distance between the moving body and the physical body.

17. An information processing method comprising:
estimating, on a basis of movement locus data indicative of a movement locus of a moving body and environment data indicative of an environment in surroundings of the moving body, a situation of a physical body in the surroundings of the moving body.

18. An information processing program for causing a computer to execute an information processing method comprising:
estimating, on a basis of movement locus data indicative of a movement locus of a moving body and environment data indicative of an environment in surroundings of the moving body, a situation of a physical body in the surroundings of the moving body.
